(19) United States
(12) Patent Application Publication
(10) Pub. No.: US 2004/0186997 A1
(43) Pub. Date: Sep. 23, 2004

(54) Encrypted data sharing system and encrypted data sharing method

(75) Inventor: Shinji Todaka, Kanagawa (JP)

Correspondence Address: ROSSI & ASSOCIATES, P.O. BOX 826, ASHBURN, VA, 20146-0826, US

(73) Assignee: CANON KABUSHIKI KAISHA

(21) Appl. No.: 10/768,628

(22) Filed: Jan. 30, 2004

(30) Foreign Application Priority Data
Jan. 31, 2003 (JP) 2003-024819

(51) Int. Cl. H04L 9/00

(52) U.S. Cl. 713/168

(57) ABSTRACT

An encrypted data sharing system that is capable of increasing the security of data without sacrificing the convenience of having the data shared. A client site (A) 102 is connected to a data warehouse server (data management server) 101 via a communication network, and can register data encrypted using a predetermined encryption key in the data warehouse server 101. A client site (B) 103 is connected to the data warehouse server 101 via the communication network, and can refer to the encrypted data registered in the data warehouse server 101. The client site (A) 102 is comprised of a registering unit that appends key issuer information to the encrypted data and registers encrypted data with the key issuer information appended thereto in the data warehouse server 101, and the client site (B) 103 is comprised of an acquiring unit operable when decoding the encrypted data acquired from the document warehouse server 101, to acquire the encryption key from the client site (A) 102 based on the key issuer information appended to the encrypted data.

### BACKGROUND OF THE INVENTION

1. Field of the Invention

The present invention relates to an encrypted data sharing system and encrypted data sharing method which are applied to a document management system or the like used by a plurality of users, in which data encrypted at a client using a predetermined encryption key is registered in a data management server on a communication network so as to share the encrypted data on the communication network.

2. Description of the Related Art

The digitization of documents has made progress in office environments including a document management system, and an electronic document warehouse service or the like, in which documents are stored in a document management server on the Internet so as to share documents between different sites, have been provided (see Japanese Laid-Open Patent Publication (Kokai) No. 2001-175516, for example).

Use of this kind of electronic document warehouse service provides the advantages that it is possible to dispense with the provision of a separate document management server in each company facility and to share documents between different sites even without a server administrator or other person with specialized knowledge.

However, the conventional document management system mentioned above has a security problem that the provider of the electronic document warehouse service can easily know the contents of a document registered in the document management server and document data is transmitted in an unprotected state on the network.

A method is also possible in which documents are registered in the document management server after being encrypted at a client using an encryption key. In this case, however, if the same encryption key is used by different sites, security cannot be ensured, while if different encryption keys are used, other users cannot access the contents of the documents.

### SUMMARY OF THE INVENTION

It is an object of the present invention to provide an encrypted data sharing system and encrypted data sharing method that are capable of increasing the security of data without sacrificing the convenience of having the data shared.

To attain the above object, in a first aspect of the present invention, there is provided an encrypted data sharing system comprising a communication network, a data management server, at least one first client connected to the data management server via the communication network, for registering data encrypted using a predetermined encryption key in the data management server, and at least one second client connected to the data management server via the communication network, for referring to the encrypted data registered in the data management server, wherein the first client comprises a registering unit that appends key issuer information to the encrypted data and registers encrypted data with the key issuer information appended thereto in the data management server, and the second client comprises an acquiring unit operable when decoding the encrypted data acquired from the document management server, to acquire the encryption key from the first client based on the key issuer information appended to the encrypted data.

With the above construction, only encrypted data is handled by the document management server and is transferred on the data transfer path. As a result, the security of data can be increased without sacrificing the convenience of having the data shared.

Preferably, the first client further comprises a user authentication unit that verifies whether an operator is a registered user, an encryption key storing unit that stores encryption keys in association with registered users, a data encryption unit that encrypts data using the encryption key, and an encryption key transferring .unit operable when an encryption key acquisition request has been received from the second client, to transfer an encryption key corresponding to the verified registered user to the second client.

Preferably, the first client further comprises an encryption key generating unit that generates the encryption key, the encryption key generation unit being operable when an arbitrary user is additionally registered, to generate an encryption key corresponding to the additionally registered user.

Preferably, the registering unit is operable when data is encrypted by the data encryption unit using the predetermined encryption key, to append the key issuer information to the encrypted data, and the acquiring unit is operable to acquire the encryption key from the first client based on the key issuer information and the second client comprises a decryption unit operable to decrypt the encrypted data using the acquired encryption key.

To attain the above object, in a second aspect of the present invention, there is provided an encrypted data sharing method used in an encrypted data sharing system including a data management server on a communication network, a first client that registers data encrypted using a predetermined encryption key in the data management server, and a second client that refers to the encrypted data registered in the data management server, the method comprising a registering step in which the first client appends key issuer information to the encrypted data and the encrypted data to which the key issuer information has been appended is registered in the document management server, and an acquiring step in which the second client acquires the encryption key based on the key issuer information appended to the encrypted data when decrypting the encrypted data acquired from the document management server.

Preferably, the encrypted data sharing method further comprises a user authentication step in which the first client verifies whether an operator is a registered user, an encryption key storage step in which the first client stores an encryption key associated with a registered user, a data encryption step in which the first client encrypts data using the encryption key, and an encryption key transferring step in which the first client transfers the encryption key corresponding to the verified registered user to the second client when an encryption key acquisition request has been received from the second client.

Preferably, the encrypted data sharing method further comprises an encryption key generating step in which the first client generates an encryption key, and when an arbitrary user is additionally registered, an encryption key corresponding to the additionally registered user is simultaneously generated in the encryption key generating step.

Preferably, when data is encrypted in the data encryption step using the predetermined encryption key, the key issuer information is appended to the encrypted data in the registering step, and the method further comprises a decrypting step of decrypting the encrypted data using the encryption key acquired from the first client based on the key issuer information in the acquiring step.

The above and other objects, features, and advantages of the invention will become more apparent from the following detailed description taken in conjunction with the accompanying drawings.

### BRIEF DESCRIPTION OF THE DRAWINGS

FIG. 1 is a block diagram showing the construction of an encrypted data sharing system according to an embodiment of the present invention;

FIG. 2 is a diagram showing an example of the format of a table of correspondence between users and encryption keys that is stored in encryption processing boxes in the encrypted data sharing system according to the present embodiment;

FIG. 3 is a diagram showing an example of the format of encrypted data with key issuer information in the encrypted data sharing system according to the present embodiment;

FIG. 4 is a flowchart showing the procedure of a data registration process to register data in a data warehouse server 101, carried out by a client site (A) 102 in the encrypted data sharing system according to the present embodiment;

FIG. 5 is a flowchart showing the procedure of a data referring process to refer to data registered in the data warehouse server 101, carried out by a client site (B) in the encrypted data sharing system according to the present embodiment; and

FIG. 6 is a view showing an example of a screen of a client application for designating data.

### DETAILED DESCRIPTION OF THE PREFERRED EMBODIMENTS

The present invention will now be described in detail below with reference to the accompanying drawings showing a preferred embodiment thereof.

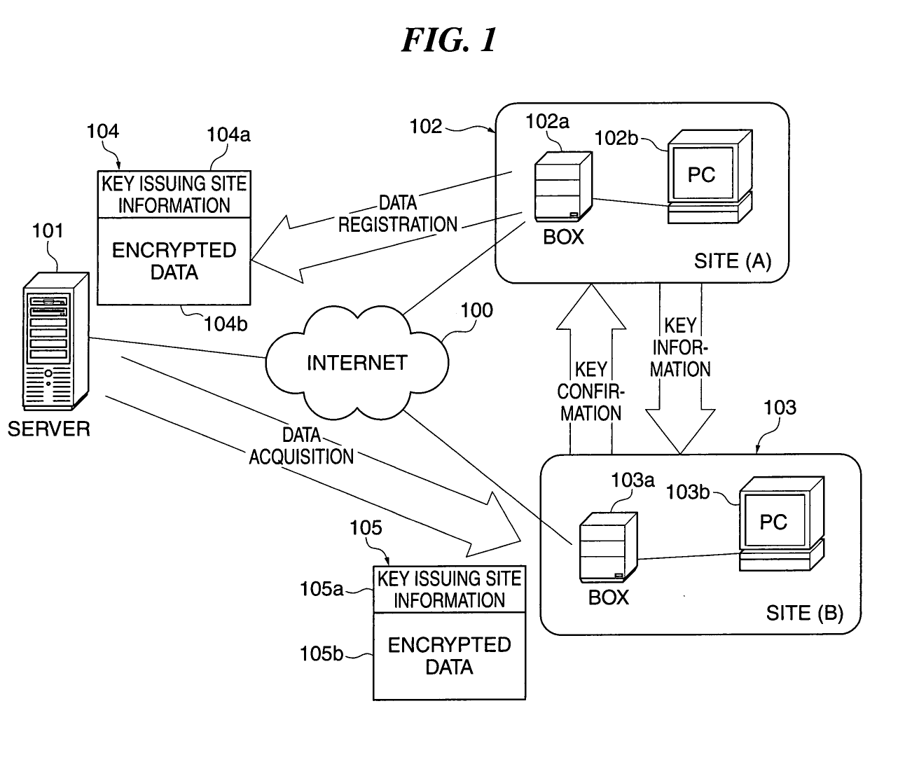

FIG. 1 is a block diagram showing the construction of an encrypted data sharing system according to an embodiment of the present invention. The encrypted data sharing system according to the present embodiment is comprised of a data warehouse server (data management server) 101 for storing encrypted data, a client site (A) (client site A) 102 for registering and/or referring to data, and a client site (B) (client site B) 103 for registering and/or referring to data.

The data warehouse server 101 stores and manages data as requested by a client site that registers data, such as the client site (A) 102 or the client site (B) 103. In the data warehouse server 101, software for data management operates on an OS (operating system), and it is possible to carry out operations such as a backing up of encrypted files as files on the OS.

However, since the files have been encrypted, it is not possible to refer to the contents of the files to read the same.

It should be noted that although it is possible for both the client site (A) 102 and the client site (B) 103 to both register and refer to data, in the present embodiment, it is assumed that the client site (A) 102 functions as a data registering site that registers data and the client site (B) 103 functions as a referring site that refers to data.

The client site (A) 102 as the data registering site is provided therein with an encryption processing box 102a that is in charge of encryption and user authentication, and a client PC (personal computer) 102b that executes processing for fetching and reading data. Here, a plurality of client PCs 102b can be provided in the site.

The client site (B) 103 as the data browsing site is provided therein with an encryption processing box 103a that is in charge of decryption of encrypted data and user authentication, and a client PC (personal computer) 103b that executes processing for fetching and reading data. Here, a plurality of client PCs 103b can be provided in the site.

Further, in FIG. 1, reference numerals 104, 105 designate encrypted data with appended information, i.e. key issuing site information (key issuer information) 104a, 105a appended to encrypted data 104b, 105b.

Next, a general flow of data processing in the encrypted data sharing system according to the present embodiment will be described with reference to FIG. 1.

When data is registered, data fetched from one of the client PCs 102b is encrypted by the encryption processing box 102a. At this time, an encryption key stored corresponding to the user in the encryption processing box 102a is used to encrypt the data.

The key issuing site information 104a, which indicates an address of the client site (A) 102, is appended to the encrypted data 104b generated by the encrypting, and the resulting data is sent to the data warehouse server 101 as the information-appended encrypted data 104. The data warehouse server 101 stores and manages the information-appended encrypted data 104 as it is.

When reference is made to data, a data acquisition request from another client PC 103b is sent to the data warehouse server 101. The data warehouse server 101 transfers the information-appended encrypted data 105, in which the key issuing site information 105a has been appended to the encrypted data 105b, to the client site (B) 103.

The encryption processing box 103a that has received the information-appended encrypted data 105 inquires of the issuer site (A) 102 an encryption key based on the key issuing site information 105a appended to the encrypted data 105b. In response to the inquiry, the issuer site (A) 102 carries out user authentication, and when the user authentication is successful, transfers the encryption key to the encryption processing box 103a. Upon receiving the encryption key, the encryption processing box 103a decrypts the encrypted data 105b and transfers decrypted data to the client PC 103b. In the present embodiment, encryption keys function not only as keys for encrypting data but also as keys for decrypting the encrypted data.

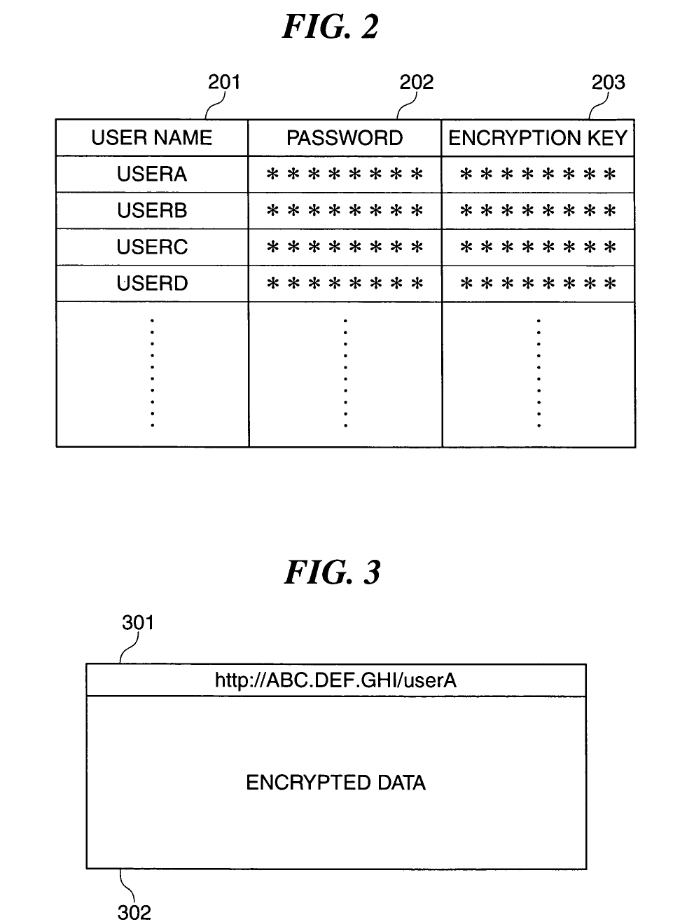

FIG. 2 is a diagram showing an example of the format of a table of correspondence between users and encryption keys that is stored in encryption processing boxes 102a, 103a in the encrypted data sharing system according to the present embodiment.

The table shown in FIG. 2 is comprised of three elements, namely, user names 201, passwords 202, and encryption keys 203. The passwords 202 and the encryption keys 203 are encrypted and stored in the encryption processing boxes 102a, 103a. When a user is newly registered in the table, an encryption key 203 corresponding to the new user is generated by the encryption processing box 102a, 103a and is reflected in the table.

FIG. 3 is a diagram showing an example of the format of data encrypted in the encryption processing boxes 102a, 103a in the encrypted data sharing system according to the present embodiment. Key issuer information 301 (which corresponds to the key issuing site information 104a, 105a in FIG. 1) is appended to encrypted data 302 (which corresponds to the encrypted data 104b, 105b in FIG. 1). In FIG. 3, a URL is given as the key issuer information 301, but other information such as an IP address or a mac address that can identify the issuer on the network can be used.

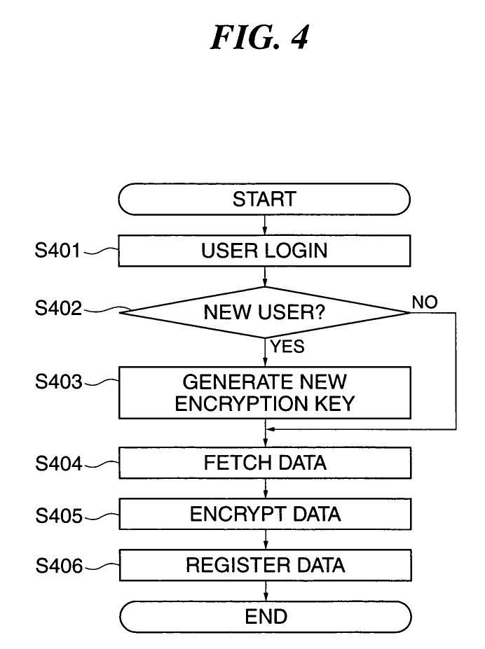

FIG. 4 is a flowchart showing the procedure of a data registration process to register data in the data warehouse server 101, carried out by a client site (A) 102 in the encrypted data sharing system according to the present embodiment.

First, in a step S401, to register data in the data warehouse server 101, the user has to be subjected to user authentication at the client site (A) 102. To this end, login processing is carried out at the client site (A) 102. Authentication processing is carried out using the encryption processing box 102a and a client application for a document management system installed on the client PC 102b, and it is confirmed whether an input from the user is proper, based on the user names 201 and the passwords 202 in the table in the encryption processing box 102a shown in FIG. 2.

Then, in a step S402, it is determined whether the user who has logged in the login processing in the step S401 is registered in the table. When it is determined that the user is a new user not registered in the table, the process proceeds to the next step S403, where a new encryption key is generated and the user is registered as a new user, before the process proceeds to a step S404.

Once the user has been confirmed as a registered user, the session is maintained until the client application is closed, and thereafter the subsequent processing is carried out with the user as the registered user.

On the other hand, when it is determined in the step S402 that the user is not a new user, the process skips over the step S403 to the step S404.

In the step S404, the client application carries out processing for fetching data to be registered in the data warehouse server 101. This fetching of data may be carried out using a scanner, or alternatively a file on the OS can be fetched as it is.

Then, in a step S405, the encryption processing box 102a carries out encryption processing on the data fetched in the step S404 using the encryption key corresponding to the user. The encryption processing is carried out by generating information-appended encrypted data with the key issuer information 301 for identifying the key issuer to the encrypted data 302. In the present embodiment, the encryption processing box 102a is dedicated to the encryption processing, but this is not limitative to the present invention, but the encryption processing may be executed by the client application.

Then, in a step S406, the information-appended encrypted data generated in the step S405 is registered in the data warehouse server 101, and the present process is terminated.

It should be noted that the communication between the client site (A) 102 and the data warehouse server 101 is carried out using TCP/IP and the basic processing relating to TCP/IP is executed by the OS.

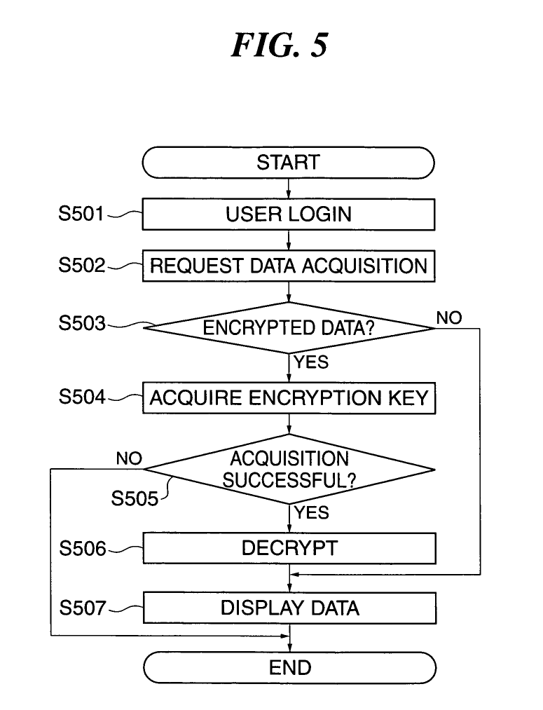

Next, a description will be given of a data referring process to refer to data registered, carried out by a client site (B) in the data warehouse server 101 with reference to a flowchart of FIG. 5.

When referring to data, first, in a step S501, login processing is carried out in order for the user to be authenticated at the client site (B) 103. Authentication processing is carried out by the encryption processing box 103a and a client application for a data management system installed on the client PC 103b, and it is confirmed whether an input from the user is proper, based on the user names 201 and the passwords 202 shown in FIG. 2.

Once the user has been confirmed as a registered user, the session is maintained until the client application is closed, and thereafter the subsequent processing is carried out with the user as the registered user.

Then, in a step S502, data to be referred to is designated out of the data stored in the data warehouse server 101, and data acquisition request processing is carried out. The designation processing for the data to be referred to is carried out by the client application, and after this, the designated data is downloaded from the data warehouse server 101.

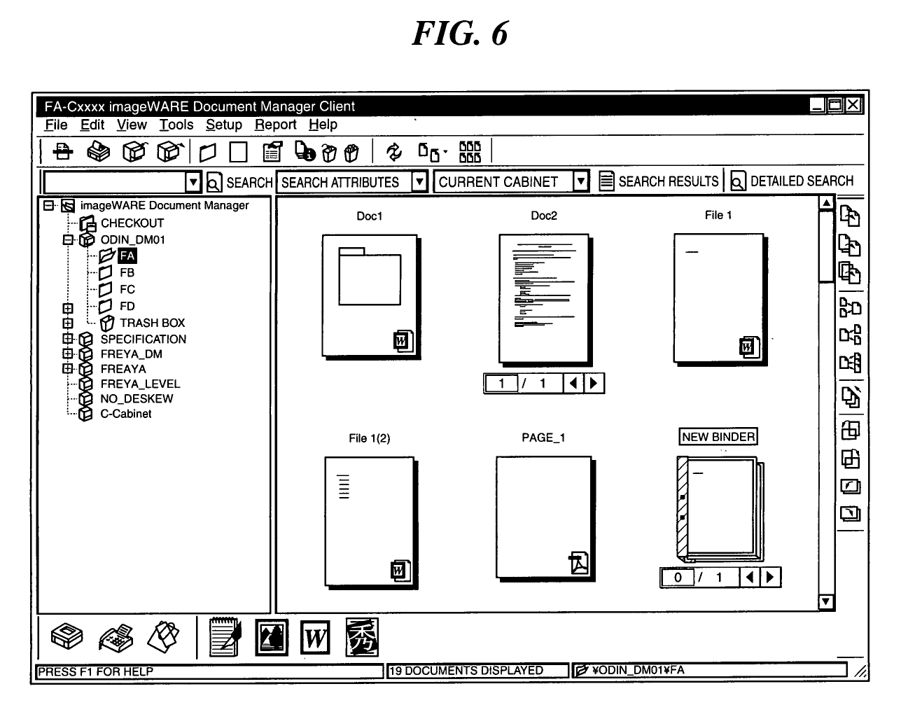

FIG. 6 is a view showing an example of a screen of the client application for designating data.

As is the case with the registering of data by the data registration client site (A) 102 in the data warehouse server 101, the processing for downloading the designated data from the data warehouse server 101 is carried out by TCP/IP communication.

Processing in steps S503, S504, S505, and S506 in FIG. 5 that will be described below is carried out by the encryption processing box 103a.

First, in the step S503, it is determined whether data that has been downloaded from the data warehouse server 101 is encrypted data. When the data is determined to be encrypted data, the process proceeds to the next step S504 where key information acquisition processing is carried out based on the key issuer information 301 appended to the encrypted data 302. In this key information acquisition processing, an inquiry for an encryption key is made to the client site (A) 102 using the user name 201 and the password 202 inputted in the login processing in the step S501. If authentication succeeds at the client site (A) 102, the encryption key can be acquired, while if the authentication fails, the encryption key cannot be acquired.

Next, in the step S505, it is determined whether the encryption key has been successfully acquired in the acquisition processing for the encryption key in the step S504. When it is determined that the acquisition process for the encryption key has been successful, the process proceeds to the step S506 where decryption processing is carried out on the encrypted data based on the encryption key acquired in the step S504.

After this, in a step S507, the decrypted data is displayed by the client application and then the present process is completed.

As described above, according to the encrypted data sharing system of the present embodiment, the client site (A) 102 for registering data registers information-appended encrypted data, generated by appending key issuer information to encrypted data, in the data warehouse server 101. When decoding acquired encrypted data, the client site (B) 103 for referring to the data acquires an encryption key by inquiring of the client site (A) 102 based on the key issuer information appended to the encrypted data to acquire the encryption key. As a result, only data that has been encrypted is handled by the data warehouse server 101 and transferred on the Internet 100 and therefore the security of the data is increased without sacrificing the convenience of having the data shared.

Although in the present embodiment the encryption key also functions as a decryption key for decrypting encrypted data, alternatively the encryption processing boxes 102a, 103a may generate an encryption key and a corresponding decryption key separately and register such keys in the table shown in FIG. 2. In the case where the encryption processing box 102a generates a decryption key corresponding to an encryption key, in the step S504 described above, the encryption processing box 103a carries out processing to acquire the generated decryption key.

It is to be understood that the object of the present invention may also be accomplished by supplying a system or an apparatus with a storage medium (or recording medium) in which a program code of software which realizes the functions of the above described embodiment is stored, and causing a computer (or CPU or MPU) of the system or apparatus to read out and execute the program code stored in the storage medium.

In this case, the program code itself read out from the storage medium realizes the functions of the embodiment described above, and hence the program code and the storage medium in which the program code is stored constitute the present invention.

Further, it is to be understood that the functions of the above described embodiment may be accomplished not only by executing a program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium, into a memory provided on an expansion board inserted into a computer or in an expansion unit connected to the computer and then causing a CPU or the like provided in the expansion board or the expansion unit to perform a part or all of the actual operations based on instructions of the program code.

Further, the above program has only to realize the functions of the above-mentioned embodiment on a computer, and the form of the program may be an object code, a program executed by an interpreter, or script data supplied to an OS.

Examples of the storage medium for supplying the program code include a RAM, an NV-RAM, a floppy (registered trademark) disk, an optical disk, a magneto-optical disk, a CD-ROM, an MO, a CD-R, a CD-RW, a DVD (DVD-ROM, DVD-RAM, DVD-RW, DVD+RW), a magnetic tape, a nonvolatile memory card, and a ROM. Alternatively, the program may be supplied by downloading from another computer, a database, or the like, not shown, connected to the Internet, a commercial network, a local area network, or the like.

What is claimed is:

1. An encrypted data sharing system comprising:
a communication network;
a data management server;
at least one first client connected to said data management server via said communication network, for registering data encrypted using a predetermined encryption key in said data management server; and
at least one second client connected to said data management server via said communication network, for referring to the encrypted data registered in said data management server,
wherein said first client comprises a registering unit that appends key issuer information to the encrypted data and registers encrypted data with the key issuer information appended thereto in said data management server, and
said second client comprises an acquiring unit operable when decoding the encrypted data acquired from said document management server, to acquire the encryption key from said first client based on the key issuer information appended to the encrypted data.

2. An encrypted data sharing system according to claim 1, wherein said first client further comprises:
a user authentication unit that verifies whether an operator is a registered user;
an encryption key storing unit that stores encryption keys in association with registered users;
a data encryption unit that encrypts data using the encryption key; and
an encryption key transferring unit operable when an encryption key acquisition request has been received from said second client, to transfer an encryption key corresponding to the verified registered user to said second client.

3. An encrypted data sharing system according to claim 2, wherein said first client further comprises an encryption key generating unit that generates the encryption key, said encryption key generation unit being operable when an arbitrary user is additionally registered, to generate an encryption key corresponding to the additionally registered user.

4. An encrypted data sharing system according to claim 2, wherein said registering unit is operable when data is encrypted by said data encryption unit using the predetermined encryption key, to append the key issuer information to the encrypted data, and said acquiring unit is operable to acquire the encryption key from said first client based on the key issuer information and said second client comprises a decryption unit operable to decrypt the encrypted data using the acquired encryption key.

5. An encrypted data sharing method used in an encrypted data sharing system including a data management server on a communication network, a first client that registers data encrypted using a predetermined encryption key in the data management server, and a second client that refers to the encrypted data registered in the data management server, the method comprising:
a registering step in which the first client appends key issuer information to the encrypted data and the encrypted data to which the key issuer information has been appended is registered in the document management server; and
an acquiring step in which the second client acquires the encryption key based on the key issuer information appended to the encrypted data when decrypting the encrypted data acquired from the document management server.

6. An encrypted data sharing method according to claim 5, further comprising:
a user authentication step in which the first client verifies whether an operator is a registered user;
an encryption key storage step in which the first client stores an encryption key associated with a registered user;
a data encryption step in which the first client encrypts data using the encryption key; and
an encryption key transferring step in which the first client transfers the encryption key corresponding to the verified registered user to the second client when an encryption key acquisition request has been received from the second client.

7. An encrypted data sharing method according to claim 6, further comprising an encryption key generating step in which the first client generates an encryption key, and wherein when an arbitrary user is additionally registered, an encryption key corresponding to the additionally registered user is simultaneously generated in said encryption key generating step.

8. An encrypted data sharing method according to claim 6, wherein when data is encrypted in said data encryption step using-the predetermined encryption key, the key issuer information is appended to the encrypted data in said registering step, and said method further comprises a decrypting step of decrypting the encrypted data using the encryption key acquired from the first client based on the key issuer information in said acquiring step.
